(19) United States
(12) Patent Application Publication
(10) Pub. No.: US 2004/0123235 A1
(43) Pub. Date: Jun. 24, 2004

(54) System and method for displaying and updating patent citation information

(76) Inventors: Chien-Fa Yeh, Tu-Chen (TW); Xin Cao, Shenzhen (CN); Chung-I Lee, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/404,886

(22) Filed: Mar. 31, 2003

(30) Foreign Application Priority Data
Dec. 20, 2002 (TW) 91136957

(51) Int. Cl. G06F 17/21

(52) U.S. Cl. 715/513

(57) ABSTRACT

A system for displaying patent analysis information includes a patent information table (410), a citation analyzing module (401), an XML (extensible markup language) converting module (310), an image converting module (320), and a user processing module (301). The patent information table stores summary data on patents. The citation analyzing module is used to generate citation links among patents in accordance with data stored in the patent information table, and to generate patent citation data downloading instructions to synchronize patent citation information with up-to-date citation data stored in intellectual property information websites. The XML converting module is used to convert patent citation information into XML documents. The image converting module is used to convert XML documents into star-hyperbolic trees each including a plurality of nodes. The user processing module is used to receive patent analysis orders, and has the function of displaying star-hyperbolic trees on a display unit (250).

### FIELD OF THE INVENTION

The present invention relates to a system and method for analyzing data, and especially to a system and method for displaying patent citation information and updating patent citation information in real time.

### BACKGROUND OF THE INVENTION

Patents are becoming more and more important to a manufacturing business's success, especially in today's globalized economy. Patents can be viewed as a new type of currency in this global economy. A good way to make use of patents is to search and analyze public patent databases, which are vast technological storehouses of information. The patent databases provide not only information on technologies, but also information on inventors and assignees of inventions. To search and analyze the patent databases is valuable for conducting activities such as licensing, infringement litigation, enforcement, technical research, and product development. Nowadays, numerous government patent offices have patent databases open to the public. Such offices include the United States Patent and Trademark Office (USPTO), the European Patent Office (EPO), the State Intellectual Property Office of the People's Republic of China (CPO), and the Japanese Patent Office (JPO). These patent databases are freely accessible through their respective web sites on the Internet.

However, few corporations conduct significant patent searching and analysis. One important reason for this is the difficulty in identifying relevant patents, and the difficulty in analyzing patents. Any major patent database contains an overwhelming number of patents, only a fraction of which are useful to a particular corporation. It is generally difficult for a corporation to efficiently search for useful patents. Even if the corporation finds useful patents, conducting patent analysis manually is a very tedious and time-consuming task.

Recently, technology for displaying information in image form has developed significantly. For example, U.S. Pat. No. 6,300,957 entitled “Mapping a node-link structure to a rendering space beginning from any node” discloses a method for converting a node-link structure into a hyperbolic tree. Through this technology, vast information can be shown in a simple image.

This technology is widely used in software tools used for patent citation analysis. But these software tools do not necessarily analyze the most up-to-date citation data, and thus cannot indicate the latest trends in a particular area of technology. Analysis results produced by these tools tend to be rather simple, and are of limited relevance to the user. Thus the potential usefulness of huge databases of patents available online cannot be fully exploited.

### SUMMARY OF THE INVENTION

Accordingly, an objective of the present invention is to provide a system for displaying up-to-date patent citation information in a star-hyperbolic tree.

Another objective of the present invention is to provide a method for displaying up-to-date patent citation information in a star-hyperbolic tree.

In order to achieve the first above-mentioned objective, a system for displaying and updating patent citation information in accordance with the present invention comprises a patent information table, a citation analyzing module, an extensible markup language (XML) converting module, an image converting module and a user processing module. The patent information table stores summary data on patents. The citation analyzing module is used to generate citation links among patents in accordance with data stored in the patent information table, and to generate patent citation data downloading instructions to synchronize patent citation information with up-to-date citation data stored in intellectual property information websites. The XML converting module is used to convert patent citation information into XML documents. The image converting module is used to convert XML documents into star-hyperbolic trees each including a plurality of nodes. The user processing module is used to receive patent analysis orders, and has the function of displaying star-hyperbolic trees on a display unit.

In order to achieve the second above-mentioned objective, a method for displaying and updating patent citation information in accordance with the present invention comprises the steps of: (a) reading patent citation data stored in a patent information table, and generating citation links among patents; (b) converting patent citation information into a star-hyperbolic patent citation tree, and displaying the patent citation tree on a display unit of a client computer; (c) downloading up-to-date patent citation data from at least one intellectual property information website; and (d) updating the patent citation links, and redisplaying the patent citation tree.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a system for displaying and updating patent citation information in accordance with a preferred embodiment of the present invention, the system comprising a database server, a file server, an application server and a plurality of client computers;

FIG. 2 is a schematic diagram of hardware infrastructure of one of the client computers of FIG. 1;

FIG. 3 is a block diagram of function modules of said one client computer of FIG. 1;

FIG. 4 is a block diagram of function modules of the application server of FIG. 1, and of communication links among said one client computer, the application server, the database server and the file server;

FIG. 5A is a schematic illustration of an exemplary patent information table that is stored in the database server;

FIG. 5B is a block diagram of a patent citation tree in accordance with the present invention;

FIG. 5C illustrates an XML document corresponding to the patent citation tree of FIG. 5B;

FIG. 5D is a schematic illustration of the patent citation tree of FIG. 5B displayed in a display unit of said one client computer;

FIG. 6 is a flow chart of displaying and updating patent citation information according to the present invention;

FIG. 7 is a flow chart of details of one step of FIG. 6, namely generating patent citation information;

FIG. 8 is a flow chart of details of another step of FIG. 6, namely displaying patent citation information;

FIG. 9 is a flow chart of one step of FIG. 8, namely converting patent citation information into an XML document; and

FIG. 10 is a flow chart of still another step of FIG. 6, namely updating patent citation information.

### DETAILED DESCRIPTION OF PREFERRED EMBODIMENTS OF THE INVENTION

Reference will now be made to the drawings to describe the present invention in detail.

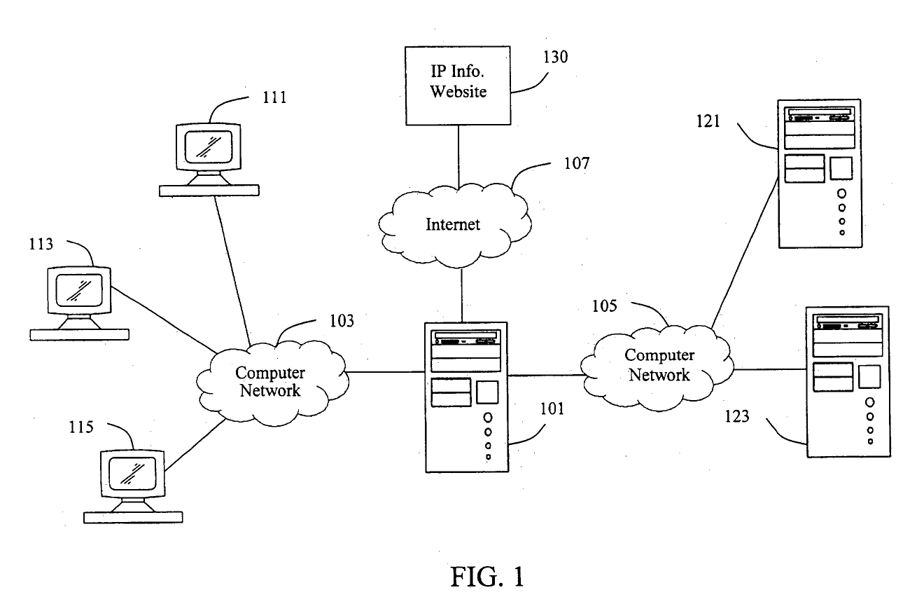

FIG. 1 is a schematic diagram of a system for displaying and updating patent citation information in accordance with a preferred embodiment of the present invention. The system for displaying and updating patent citation information comprises a three-layer information system. The three-layer information system comprises a data access layer, a business logic layer, and a presentation layer. The data access layer comprises a database server 121 and a file server 123. The business logic layer comprises an application server 101. The presentation layer comprises a plurality of client computers. For the purposes of conveniently illustrating the preferred embodiment of the present invention, three client computers 111, 113, 115 are shown and described hereinafter. Computer communication networks 103, 105 interconnect all the above-mentioned apparatuses. The application server 101 connects with a plurality of intellectual property (IP) information websites 130 (only one shown) via the Internet 107, and downloads patent information from the intellectual property information websites 130.

The application server 101 comprises core and mutable enterprise logic (such as rules, execution, and management) of the system for displaying patent analysis information. The application server 101 processes input of users, and returns results of processing to users. The database server 121 stores all structured data on an enterprise, and is used for managing processing of data stored in a database located in the database server 121. The file server 123 stores all unstructured data on the enterprise, and is used for managing processing of data stored in a database located in the file server 123. Such processing of the database server 121 and the file server 123 includes reading, writing, deleting, modifying, and backup. The client computers 111, 113, 115 have the function of receiving orders input by users, and displaying results of implementation of such orders.

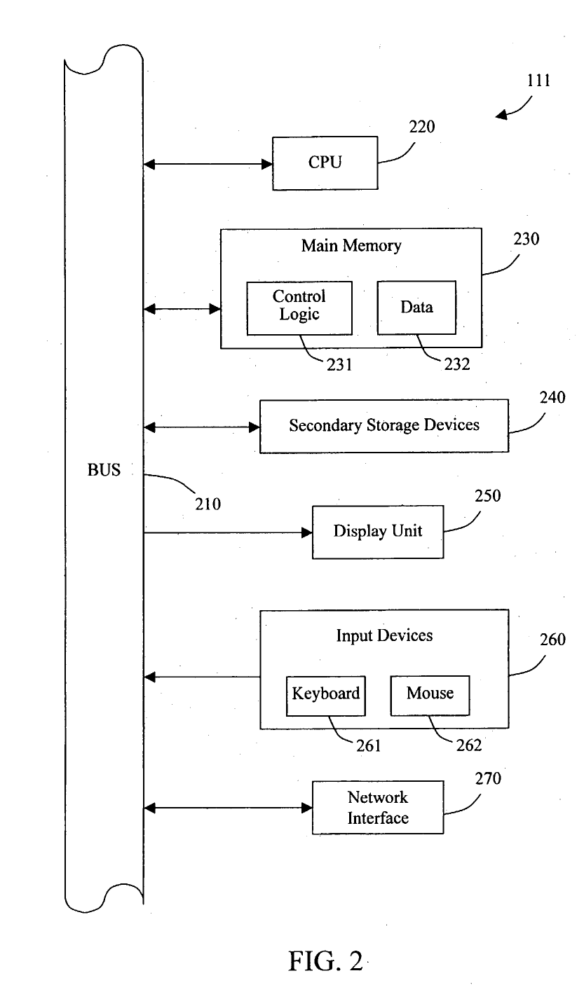

FIG. 2 is a schematic diagram of hardware infrastructure of the client computer 111. It should be noted that the client computers 113, 115, the application server 101, the database server 121 and the file server 123 each comprise hardware infrastructure similar to that of the client computer 111. The client computer 111 comprises the following units: a central processing unit (CPU) 220, a main memory 230, a plurality of secondary storage devices 240, a display unit 250, a plurality of input devices 260, and one or more network interfaces 270. Each of said units is connected with a common system bus 210, to communicate with other of said units.

The CPU 220 is the functional core of the client computer 111, and is used for processing all computing tasks in the client computer 111. The bus 210 is used for data exchange among said units in the client computer 111. The main memory 230 is high-speed random access memory (RAM) and read only memory (ROM), and comprises storage areas for control logic 231 and data 232. The main memory 230 may also include any additional or alternative high-speed memory device or memory circuitry. The secondary storage devices 240 are used to store all application programs and other data on the enterprise. The secondary storage devices 240 are preferably long term storage devices. Such devices may include ROM, optical or magnetic disks, organic memory, or any other suitable volatile or non-volatile mass storage system. The display unit 250 displays prompting information for users. Such information assists users to input orders for processing of data, and to view results of implementation of such orders. The input devices 260 receive control orders from users, and comprise a keyboard 261 and a mouse 262. Each network interface 270 controls communication between the client computer 111 and other computing devices.

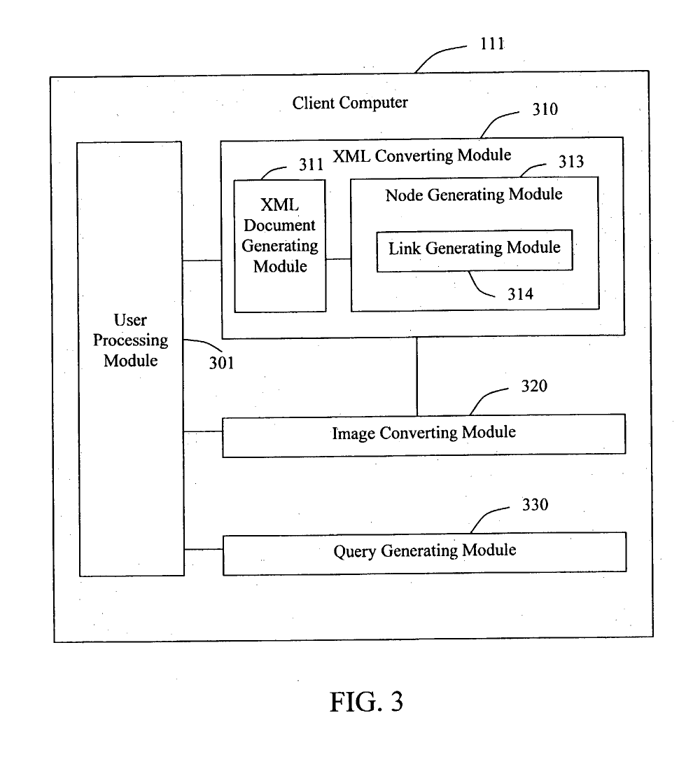

FIG. 3 is a block diagram of function modules of the client computer 111. The client computer 111 comprises a user processing module 301, an XML (Extensible Markup Language) converting module 310, an image converting module 320, and a query generating module 330.

The user processing module 301 comprises a Graphical User Interface (GUI) for users to input data processing orders. The GUI also displays results of implementation of the orders via the display unit 250. The user processing module 301 is connected with the XML converting module 310 and the query generating module 330, for sending of user orders thereto. The user processing module 301 is also connected with the image converting module 320, for receiving results of implementation of the user orders therefrom.

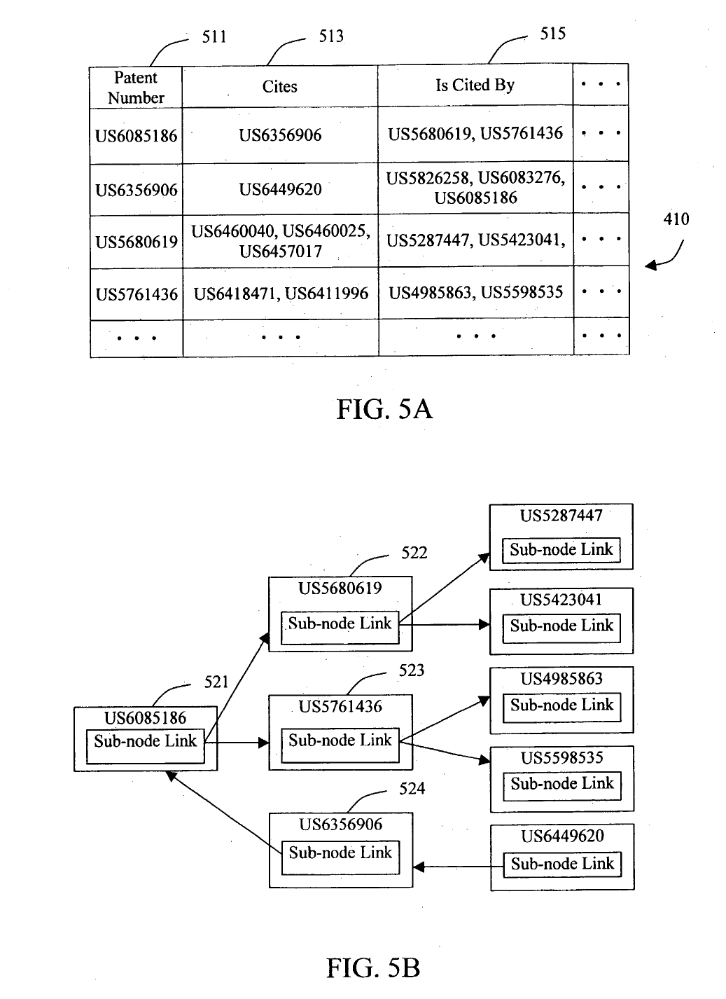

The XML converting module 310 is used for converting data stored in the database server 121 into an XML document having particular data structures. Such conversion is described in detail below with reference to FIG. 5C. The XML converting module 310 comprises an XML document generating module 311, and a node generating module 313. The node generating module 313 packs patent analysis data into a node data structure. Such packing is described in detail below with reference to FIG. 5B. The node generating module 313 further comprises a link generating module 314. The link generating module 314 generates links between nodes, and adds the links to the node data structure. The XML document generating module 311 generates an empty XML document, and stores the node data structure generated by the node generating module 313 in the XML document. The XML document is a temporary document stored in the data 232 of the main memory 230 of the client computer 111.

The image converting module 320 converts the XML document into a star-hyperbolic tree. The star-hyperbolic tree includes a plurality of nodes and links between the nodes. The structure of the star-hyperbolic tree is described in detail below with reference to FIG. 5D.

The query generating module 330 converts patent downloading orders input by users via the user processing module 301 into queries that the application server 101 can read, and sends the queries to the application server 101.

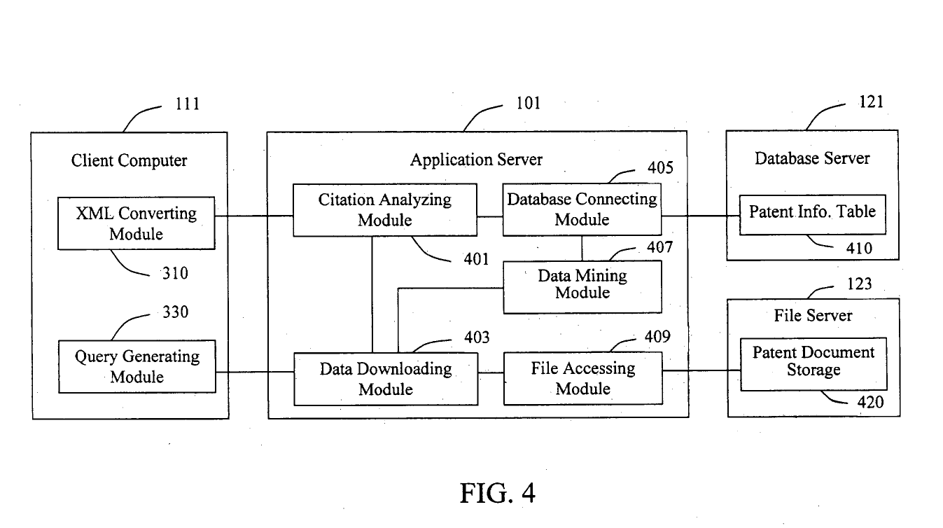

FIG. 4 is a block diagram of function modules of the application server 101, and of communication links among the client computer 111, the application server 101, the database server 121 and the file server 123. The application server 101 comprises a citation analyzing module 401, a database connecting module 405, a data mining module 407, a data downloading module 403, and a file accessing module 409.

The database connecting module 405 is used for connecting the application server 101 with the database server 121. The database connecting module 405 controls data communication between applications and source data. Applications of the application server 101 can access data stored in different database management systems (DBMSs) via the database connecting module 405. In the preferred embodiment of the present invention, the applications can access data stored in a patent information table 410 that is stored in the database server 121. The patent information table 410 is described in detail below with reference to FIG. 5A. The file accessing module 409 connects the application server 101 with the file server 123. Applications of the application server 101 can access data stored in a patent document storage 420 of the file server 123.

The data downloading module 403 receives patent downloading queries from the query generating module 330 of the client computer 111. The data downloading module 403 downloads patents from the IP information websites 130 via the Internet 107 (see FIG. 1) in accordance with the patent downloading queries. The downloaded patents are in the form of electronic documents, typically including HTML (hypertext markup language) format documents. The downloaded patents are stored in the file server 123 via the file accessing module 409, and summary data on patents in HTML format are sent to the data mining module 407.

The data mining module 407 mines the summary data on patents in HTML format, using tags contained in the relevant HTML files as identifiers. The summary data on patents include the following information on each patent: title, assignee, cited by, and cites. The summary data on patents are stored in the patent information table 410 via the database connecting module 405.

In the preferred embodiment of the present invention, patents are grouped into a plurality of projects. Each project comprises a plurality of patents having some commonality. The commonality may, for example, be a same assignee within a same area of technology. Summary data on each patent in a same project are stored in a same patent information table 410. The citation analysis module 401 is used to generate citation information of a designated patent according to patent summary information stored in the patent information table 410. Such citation information can assist users analyze development trends and directions of technologies.

The above-mentioned modules described in relation to FIGS. 3 and 4 can also be comprised in a single computing device, and the single computing device can achieve all the functions of the system for displaying patent analysis information.

FIGS. 5A-5D are provided in relation to generating a patent citation tree.

FIG. 5A is a schematic illustration of an exemplary patent information table 410. The patent information table 410 comprises columns for patent number 511, cites 513, and cited by 515. All data stored in the patent information table 410 have been mined from patent documents downloaded from the IP information websites 130.

The column for patent number 511 stores patent numbers of patents. The corresponding patents may be completely or partially stored in the patent document storage 420 of the file server 123. The column for cites 513 stores patent numbers that are cited by a particular patent. The column for cited by 515 stores patent numbers of patents that cite a particular patent. For example, the patent with patent number “U.S. Pat. No. 6,085,186” cites the patent with patent number “U.S. Pat. No. 6,356,906,” and is cited by the patent with patent number “U.S. Pat. No. 5,680,619.”

The patent information table 410 illustrated is exemplary of the preferred embodiment of the present invention. In alternative embodiments, the patent information table 410 may include one or more other columns in lieu of and/or in addition to the above-described columns 511, 513, 515. Such other columns can provide other summary data on patents. Furthermore, the patent information table 410 may instead be replaced by two or more similar tables.

FIG. 5B is a block diagram of a patent citation tree in accordance with the present invention. The patent citation tree comprises a plurality of nodes. Each node comprises a sub-node link connecting the node with its respective one or more sub-nodes.

The patent citation tree is generated in accordance with data stored in the patent information table 410. The citation analyzing module 401 generates citation links among a plurality of patents, according to the summary data stored in the patent information table 410. The node generating module 313 of the client computer 111 generates a node data structure. Each node in the node data structure represents a patent. The link generating module 314 generates sub-node links between the nodes, and adds sub-node links to the node data structure. Each sub-node link represents one or more citation links, and connects one node with its respective one or more sub-nodes. In some program languages, functions of any sub-node link are activated by using a pointer or a cursor.

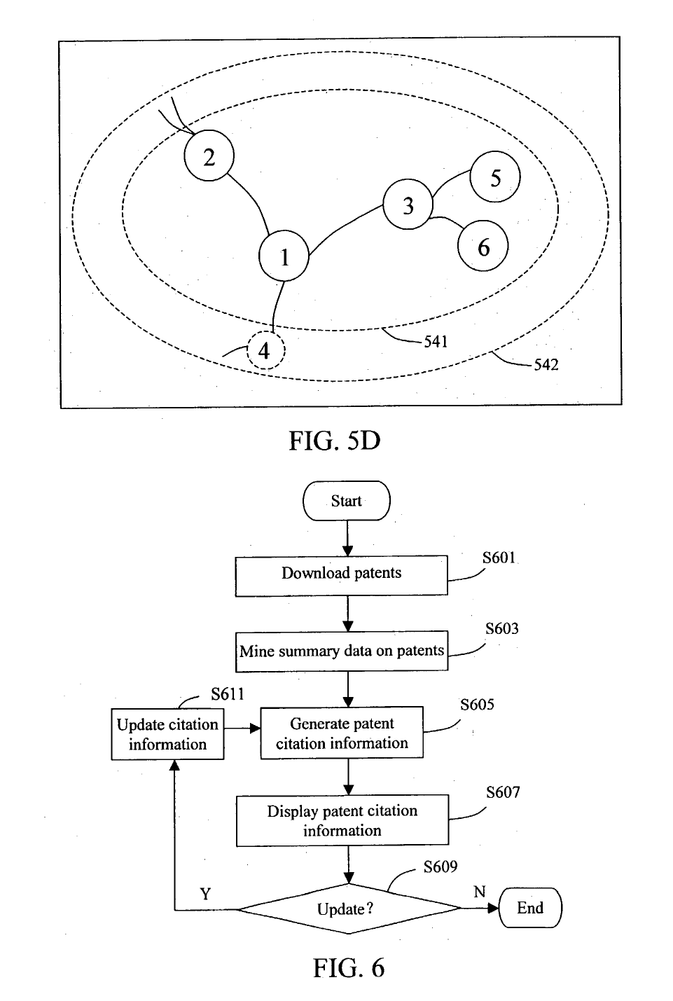

Any node that a citation link points to represents a patent that is cited by the patent represented by the node that the citation link originates from. For example, the patent that the node 521 represents cites the patents that the nodes 522 and 523 respectively represent, and is cited by the patent that the node 524 represents. A procedure for generating citation links among patents is described in detail below with reference to FIG. 7.

FIG. 5C illustrates an XML document corresponding to the patent citation tree of FIG. 5B. First, the source data upon which the invention operates must be specified using an outer-level grouping construct such as the beginning tag syntax “<ICTree backcolor=“ffffff” forecolor=“0000ff” fontsize=“12”>” shown at 531 and the ending tag syntax “</ICTree>” shown at 532. Other keywords, such as “node,” may be used in these outermost tags. FIG. 5C also illustrates that within the outmost structure, any number of nested substructures such as “node” may exist. What is required is that a predetermined keyword syntax is used to specify the source data. The gathering process performed by the image converting module 320 searches for this keyword syntax during conversion of the XML document into a patent citation tree in image format. The value of “id” (identifier) within this construct can be any syntactically correct value according to XML syntax, and will be used by the image converting module 320 to locate the corresponding source data.

FIG. 5C further illustrates that the XML document contains contents for node data structure and links between nodes. For example, the data item having the identifier “backcolor” has the value “a41200.” “a41200” is a value of an RGB (Red Green Blue) color combination which yields the color orange. Accordingly, the background color of node 533 is orange. The identifier “id=“1001”” means that the ID of node 533 is “1001” in the patent citation tree. The identifier “<flag>US006085186</flag>” means that the title of the node 533 is “US006085186.”The nested structure of node data in the XML document corresponds to links between the nodes. For example, the corresponding node of identifier 534 is a sub-node of the corresponding node of identifier 533, and is a supra-node of the corresponding node of identifier 535.

FIG. 5D is a schematic illustration of the patent citation tree of FIG. 5B displayed in the display unit 250 of the client computer 111. The image converting module 320 reads the XML document stored in the main memory 230 of the client computer 111, converts the XML document into a star-hyperbolic tree, and displays the star-hyperbolic tree in a hyperbolic plane in the display unit 250. A user can adjust a shape of the star-hyperbolic tree by dragging or clicking the mouse 262 of the client computer 111. The user can also read details of a patent by double-clicking the corresponding patent node.

The hyperbolic plane is divided into three areas. The first area is inside an ellipse 541, and is named a visible area. In the visible area, nodes and links between the nodes are all visible, such as the 1, 2, 3, 5, and 6 nodes. The second area is outside the ellipse 541, between the ellipse 541 and an ellipse 542, and is named a half-visible area. In the half-visible area, the nodes are invisible, and each one is replaced by a dot. But links between the nodes are visible, such as the links of node 4. The third area is outside the ellipse 542, and is named an invisible area. In the invisible area, the nodes and links between the nodes are all invisible.

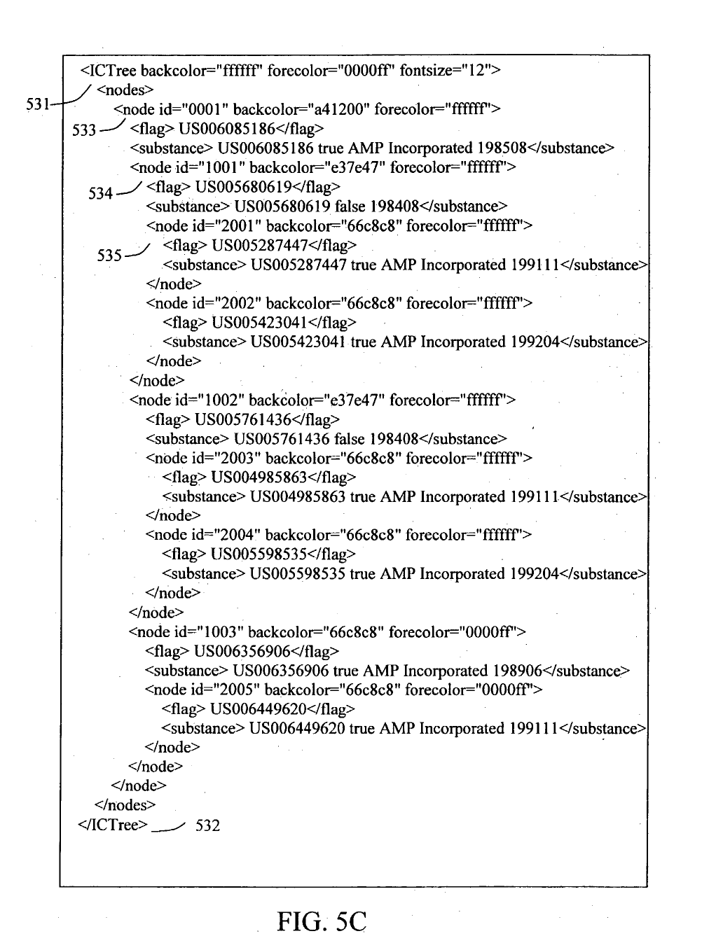

FIG. 6 is a flow chart of displaying and updating patent citation information according to the present invention. Firstly, in step S601, the GUI of the user processing module 301 receives a patent downloading order from a user, and the data downloading module 403 downloads patents in accordance with the user order. In step S603, the data mining module 407 mines summary data on patents in HTML format, using tags contained in the relevant HTML files as identifiers. The summary data on patents include patent numbers, assignees, cited by, and cites. The summary data on patents are stored in corresponding columns of the patent information table 410 via the database connecting module 405. The patent documents are stored in the patent document storage 420 via the file accessing module 409.

In step S605, when the user inputs a patent analyzing order, the citation analyzing module 401 reads the patent information table 410 via the database connecting module 405, generates patent citation information in accordance with the user order, and stores the patent citation information in a main memory of the application server 101. In step S607, the XML converting module 310 generates a plurality of nodes in accordance with the patent citation information. The nodes are arranged into a node data structure, and stored in an XML document. The image converting module 320 converts the XML document into a star-hyperbolic tree, and displays the star-hyperbolic tree in the display unit 250.

In the preferred embodiment of the present invention, in step S609, the user can update the stored patent citation information in real time. That is, the user can synchronize the stored patent citation information with information stored in the IP information websites 130. If the user wants to update the stored patent citation information, in step S611, the data downloading module 403 downloads patent citation data from the IP information websites 130, and the citation analyzing module 401 updates the stored patent citation information. Thereupon, the procedure returns to step S605. If and when the user does not want to update the stored patent citation information, the procedure is ended.

FIG. 7 is a flow chart of details of step S605 of FIG. 6, namely generating patent citation information. In step S701, the GUI of the user processing module 301 receives a patent analysis order from the user. In step S703, the citation analyzing module 401 reads the citing data on a source patent in the cites 513 column of the patent information table 410. In step S705, the citation analyzing module 401 generates respective citation links between the source patent and each cited patent in accordance with the information in the cites 513 column. In step S707, the citation analyzing module 401 reads data stored in the cites 513 and patent number 511 columns. The citation analyzing module 401 determines whether each cited patent is included in the current project, and if so, whether the cited patent has any of its own cited patents. If any cited patent is both included in the current project and has one or more of its own cited patents, in step S709, the citation analyzing module 401 generates all corresponding citation links for each such cited patent recursively. Thereafter, the procedure proceeds to step S711 described below. If no cited patent is both included in the current project and having one or more of its own cited patents, the procedure proceeds directly to step S711.

In step S711, the citation analyzing module 401 reads the cited data on the source patent in the cited by 515 column of the patent information table 410. In step S713, the citation analyzing module 401 generates respective citation links between the source patent and each citing patent in accordance with the information in the cited by 515 column. In step S715, the citation analyzing module 401 reads data stored in the cited by 513 and patent number 511 columns. The citation analyzing module 401 determines whether each citing patent is included in the current project, and if so, whether the citing patent has any of its own citing patents. If any citing patent is both included in the current project and has one or more of its own citing patents, in step S717, the citation analyzing module 401 generates all corresponding citation links for each such citing patent recursively. Thereafter, the procedure proceeds to step S719 described below. If no cited patent is both included in the current project and having one or more of its own citing patents, the procedure proceeds directly to step S719. In step S719, the citation analyzing module 401 stores the patent citation information in the main memory of the application server 101.

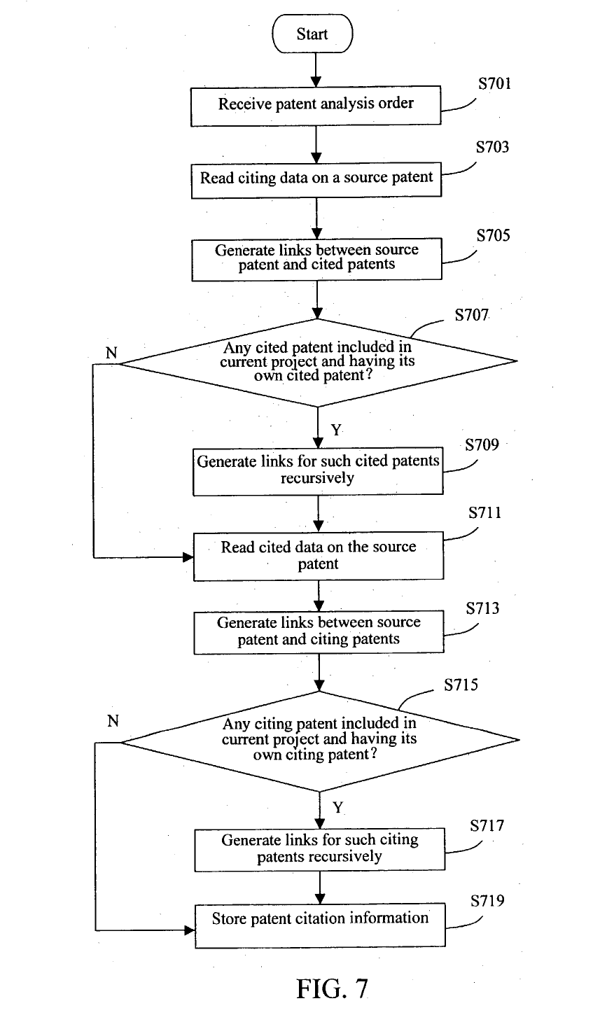

FIG. 8 is a flow chart of details of step S607 of FIG. 6, namely displaying patent citation information. In step S801, the citation analyzing module 401 receives instructions on a mode of displaying the star-hyperbolic tree. For example, the star-hyperbolic tree can display patent numbers on patent nodes, or display assignees on patent nodes. In step S803, the XML converting module 310 converts the patent citation information generated by the citation analyzing module 401 into an XML document. In step S805, the image converting module 320 converts the XML document into a star-hyperbolic tree, and displays the star-hyperbolic tree in the display unit 250.

In step S807, the GUI of the user processing module 301 receives an order from the user, and determines whether to change the mode of displaying the star-hyperbolic tree having regard to the user order. If the user wants to see another display mode, the procedure returns to step S801. If the user does not want to see another display mode, in step S809, the GUI of the user processing module 301 determines whether to save the star-hyperbolic tree having regard to the user order. If the user does not want to save the star-hyperbolic tree, the procedure is ended. If the user wants to save the star-hyperbolic tree, in step S811, the user processing module 301 stores the star-hyperbolic tree in the secondary storage devices 240, whereupon the procedure is ended.

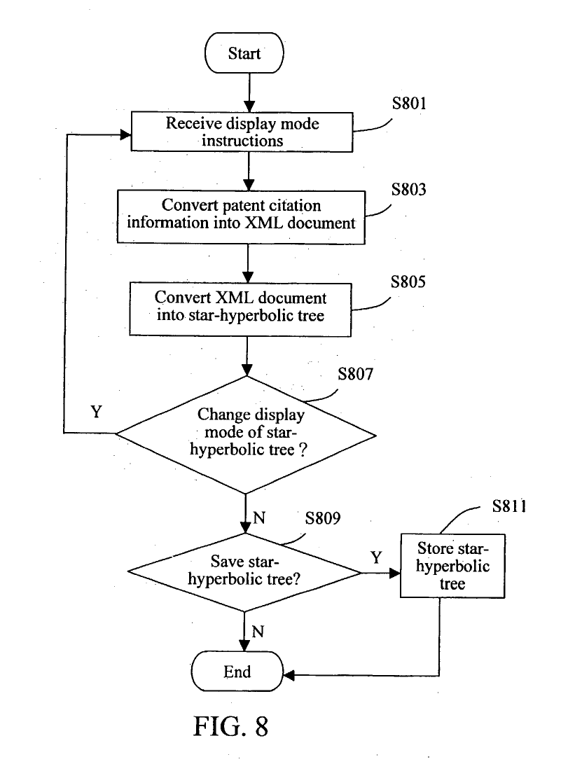

FIG. 9 is a flow chart of step S803 of FIG. 8, namely converting patent citation information into an XML document. In step S901, the XML converting module 310 reads the patent citation information. In step S903, the XML document generating module 311 generates an empty XML document for storing of the patent citation information. In step S905, the node generating module 313 generates data structure of a root-node. The data structure of the root-node includes ID, background color, foreground color, flag of the node, and so on. In step S907, the link generating module 314 generates data structure of links between the root-node and other nodes, and adds the data structure of links to the data structure of the root-node. In step S909, the node generating module 313 and the link generating module 314 generate data structure of sub-nodes recursively. In step S911, the XML document generating module 311 adds the resultant data structure of all nodes to the XML document.

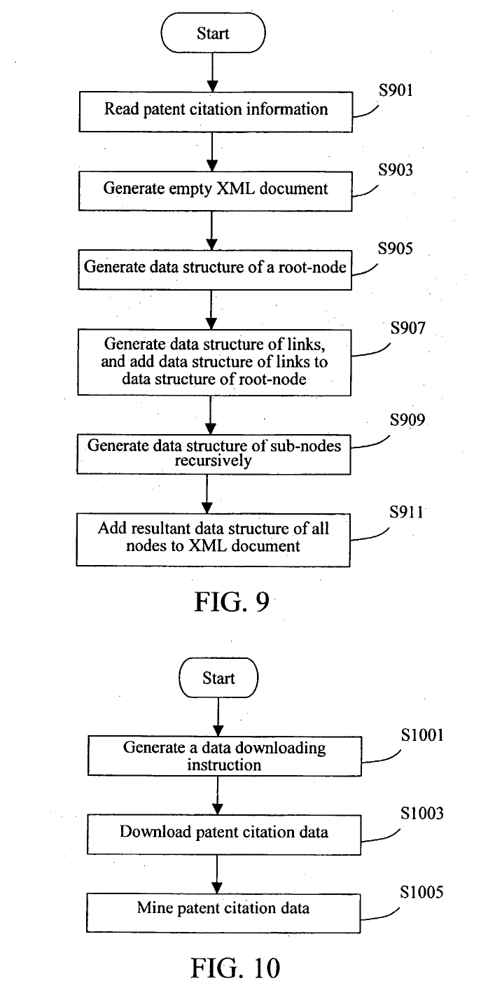

FIG. 10 is a flow chart of step S611 of FIG. 6, namely updating patent citation information. In step S1001, the citation analyzing module 401 reads the patent number of the patent to be analyzed in the patent information table 410, and generates a data downloading instruction for downloading patent citation data. In step S1003, the data downloading module 403 implements the instruction received from the citation analyzing module 401 by downloading citation data on the patent. In step S1005, the data mining module 407 mines patent citation data from HTML documents downloaded from the IP information websites 130 by the data downloading module 403, and stores the mined patent citation data in the patent information table 410.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for displaying and updating patent citation information, the system comprising a patent information table, a citation analyzing module, an extensible markup language (XML) converting module, an image converting module and a user processing module, wherein:
the patent information table stores summary data on patents;
the citation analyzing module is used to generate citation links among patents in accordance with data stored in the patent information table, and to generate patent citation data downloading instructions to synchronize patent citation information with up-to-date citation data stored in intellectual property information websites;
the XML converting module is used to convert patent citation information into XML documents;
the image converting module is used to convert XML documents into star-hyperbolic trees each including a plurality of nodes; and
the user processing module is used to receive patent analysis orders, and has the function of displaying star-hyperbolic trees on a display unit.

2. The system as claimed in claim 1, wherein the patent information table, the citation analyzing module, the XML converting module, the image converting module and the user processing module are included in a single computing device.

3. The system as claimed in claim 1, wherein the patent information table is included in a database server, the citation analyzing module is included in an application server, the XML converting module, the image converting module and the user processing module are included in a client computer, and the database server, the application server and the client computer are connected by a network.

4. The system as claimed in claim 1, wherein the patent information table comprises columns for patent number, cites, and cited by.

5. The system as claimed in claim 1, wherein each of the nodes of each of the star-hyperbolic trees represents a corresponding patent.

6. The system as claimed in claim 1, further comprising a data downloading module for downloading patent data from at least one intellectual property information website.

7. The system as claimed in claim 1, further comprising a data mining module for mining patent summary data from documents in hypertext markup language (HTML) format.

8. The system as claimed in claim 1, wherein the XML converting module further comprises a node generating module for generating node data structures for patents.

9. The system as claimed in claim 1, wherein the XML converting module further comprises a link generating module for generating citation links among patent nodes.

10. The system as claimed in claim 1, wherein a display of each of the star-hyperbolic trees is divided into a visible area, a half-visible area, and an invisible area.

11. A method for displaying and updating patent citation information, the method comprising the steps of:
reading patent citation data stored in a patent information table, and generating citation links among patents;
converting patent citation information into a star-hyperbolic patent citation tree, and displaying the patent citation tree on a display unit of a client computer;
downloading up-to-date patent citation data from at least one intellectual property information website; and
updating the patent citation links, and redisplaying the patent citation tree.

12. The method as claimed in claim 11, wherein the step of generating citation links among patents further comprises the steps of:
reading citing data on a designated patent, and generating corresponding citation links for the designated patent;
generating citation links for a cited patent recursively in accordance with citing data stored in the patent information table;
reading cited data on the designated patent, and generating corresponding citation links for the designated patent; and
generating citation links for a citing patent recursively in accordance with cited data stored in the patent information table.

13. The method as claimed in claim 11, wherein the step of converting patent citation information into a star-hyperbolic patent citation tree further comprises the steps of:
generating a data structure of nodes in accordance with patent citation information;
generating citation link information, and adding the link information to the data structure of nodes;
generating an empty XML document, and adding the data structure of nodes into the XML document; and
converting the XML document into the patent citation tree.

14. The method as claimed in claim 11, wherein the display of the star-hyperbolic patent citation tree comprises a visible area, a half-visible area, and an invisible area.

15. A method of displaying patent citation information for a user, comprising sequential steps of:
(a) receiving display mode instructions;
(b) converting corresponding patent citation information into XML document;
(c) converting said XML document into star-hyperbolic tree;
(d) changing a display mode of said star-hyperbolic tree if the use wants;
(e) back to step (a) if yes in step (d); and
(f) saving said star hyperbolic tree if no in step (d) and required by the user, or ending the method.
